(19) United States
(12) Patent Application Publication
(10) Pub. No.: US 2009/0184828 A1
(43) Pub. Date: Jul. 23, 2009

(54) Automatic driver alert device and associated method

(76) Inventor: Charles A. Speller, Newark, NJ (US)

Correspondence Address: ASHKAN NAJAFI, P.A., 6817 SOUTHPOINT PARKWAY, SUITE 2301, JACKSONVILLE, FL, 32216, US

(21) Appl. No.: 12/321,578

(22) Filed: Jan. 22, 2009

Related U.S. Application Data
(60) Provisional application No. 61/062,061, filed on Jan. 23, 2008.

(51) Int. Cl. G08B 23/00; B60Q 1/00

(52) U.S. Cl. 340/575; 340/438

(57) ABSTRACT

A driver alerting device includes body that is adapted to be worn around a driver's neck. The driver alerting device is configured to emit alert signals when a triggering event is detected. The alert signals are configured in such a manner to adequately notify the driver of the dangerous driving condition. The triggering event may be defined by a position of the driver's head/neck regions, such as when the chin or jaw line dip as the driver begins to fall asleep at the wheel. A neck position determining mechanism is provided for alerting the driver when his/her neck/head has dropped below a minimum threshold level. If such an event has occurred, at least one alert signal is emitted for notifying the driver of the dangerous situation.

### CROSS REFERENCE TO RELATED APPLICATIONS

This application claims the benefit of U.S. Provisional Application No. 61/062,061, filed Jan. 24, 2008, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to alert devices and, more particularly, to an automatic alert device for providing a convenient and effective means of rousing a driver if he/she falls asleep at the wheel.

2. Prior Art

The dangers of drinking alcohol before driving are widely known. But far too many people think little of slumping behind the wheel while fatigued, or continuing to drive while feeling drowsy. A recent survey of more than 1,000 Americans by the National Sleep Foundation found 57 percent had driven while drowsy in the past year and 23 percent had fallen asleep at the wheel. Experts estimate weary motorists who drift off the road and crash cause about 40,000 injuries and 1,550 deaths nationally each year. Symptoms of fatigue include involuntary eye closures, yawning, feeling tired, inability to stay in a lane and inattention.

Fatigue can occur at any time of the day, and safety experts say drivers who feel drowsy should take the feeling seriously. Sleep can strike without warning; it only takes a second to shut your eyes, leave your lane and crash. As such, it I typical for drowsy drivers not to realize they are falling asleep. Many drivers believe they can stay awake by rolling down the window or turning up the radio, but safety experts say these techniques simply do not work. Obviously it would be advantageous to provide a means for keeping drivers awake at the wheel.

Accordingly, a need remains for an automatic alert device in order to overcome the above-noted shortcomings. The present invention satisfies such a need by providing a device that is convenient and easy to use, lightweight yet durable in design, and designed for providing users with a convenient and effective means of rousing a driver if he/she happens to fall asleep at the wheel.

### BRIEF SUMMARY OF THE INVENTION

In view of the foregoing background, it is therefore an object of the present invention to provide a device for swiftly and effectively alerting a driver that he/she is dosing off at the wheel of a vehicle. These and other objects, features, and advantages of the invention are provided by an automatic driver alerting device for notifying a driver when a dangerous event has occurred that is associated with sleeping at the wheel

The automatic driver alerting device preferably includes a body adapted to be removably positioned about a neck of the driver. In one embodiment, the body may include first and second chambers adapted to be positioned subjacent to a face of the driver. The body may further include an intermediary coupling having opposed ends directly anchored to the first and second chambers respectively. The intermediary coupling is preferably adapted to conform to a shape of the driver neck and thereby maintain the first and second chambers anterior to the driver neck.

The present invention further includes a mechanism for detecting an occurrence of a triggering event. Such a triggering event detecting mechanism preferably generates and transmits start and stop output signals corresponding to a beginning and an end of the triggering event. A user interface is also provided for generating and transmitting a control signal in response to receiving a user input. An internal power source is electrically mated to the user interface and a first transducer is electrically coupled directly to the triggering event detecting mechanism. Advantageously, the first transducer generates and emits a first alarm signal upon receiving the start output signal such that the first transducer continuously emits the first alarm signal until receiving the stop output signal.

In one embodiment, the triggering event detecting mechanism preferably includes a plurality of sensors for detecting whether an external force is pressing downwardly against a top region of the body. Each of the sensors generates and transmits a corresponding instruction signal upon detecting the external force. Each of the instruction signals preferably includes a first numerical value embedded therein. Such a first numerical value corresponds to an intensity of the real-time external force exerted on the body so that the device 10 is able to distinguish between qualifying and non-qualifying external forces. Qualifying external forces are represented by a drive chin or jaw continuously engaging the body with a sufficient intensity associated a face dropping directly on the body. Non-qualifying external forces are represented by a quick or sudden jerk or recoil of the jaw or chin, which does not have a sufficient intensity or duration to mimic a sleeping driver.

The triggering event detecting mechanism may further include a processor electrically coupled to the sensors, which is responsive to the instruction signals. A memory may be electrically coupled to the processor and preferably includes programmable software instructions that cause the processor to generate and transmit the start and stop signals to the first transducer. The software instructions preferably included and execute a control logic algorithm that determines whether the instruction signals are qualified instruction signals based upon a user defined minimum operating parameter. The user defined minimum operating parameter preferably includes a minimum numerical value embedded in the control signal. Such a minimum numerical value corresponds to a minimum external force necessary to qualify as the triggering event, as explained hereinabove.

Notably, the control logic algorithm includes the chronological steps of: requesting the control signal from the user; receiving and extracting the minimum numerical value from the control signal; and receiving and extracting the real-time numerical values from the instruction signals respectively. If at least one of the real-time numerical values is greater than the minimum numeral value, then the processor generates and transmits a first one of the start signals to the first transducer. If the real-time numerical values are less than the minimum numeral value, then the processor generates and transmits a first one of the stop signals to the first transducer.

In one embodiment, the present may further include a second transducer electrically coupled to the triggering event detecting means, the second transducer generating and transmitting a second alarm signal upon receiving a second one of the start and stop output signals respectively. Accordingly, the control logic algorithm may further include the chronological steps of: if at least one of the real-time numerical values is greater than the minimum numeral value, then generating and transmitting the second one of the start signals to the second transducer; and if the real-time numerical values are less than the minimum numeral value, then generating and transmitting a second one of the stop signals to the second transducer.

The present invention may further include a method for notifying a driver when a dangerous event has occurred that is associated with sleeping at the wheel. Such a method preferably includes the chronological steps of: providing a body including first and second chambers and an intermediary coupling, the intermediary coupling having opposed ends directly anchored to the first and second chambers respectively; removably positioning the body about a neck of the driver by conforming the intermediary coupling to a shape of the driver neck; and positioning the first and second chambers subjacent to a face of the driver.

The method may further include the chronological steps of: maintaining the first and second chambers anterior to the driver neck; providing a user interface for generating and transmitting a control signal in response to receiving a user input; providing an internal power source electrically mated to the user interface; and providing a mechanism for detecting an occurrence of a triggering event.

The method may further include the chronological steps of: providing and electrically coupling a first transducer directly to the triggering event detecting mechanism; the triggering event detecting mechanism generating and transmitting start and stop output signals corresponding to a beginning and an end of the triggering event respectively; the first transducer generating and emitting a first alarm signal upon receiving the start output signal; and the first transducer continuously emitting the first alarm signal until receiving the stop output signal.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view showing a driver alert device, in accordance with the present invention;

FIG. 2 is a perspective view showing the driver alert device positioned about a driver's neck, during operating conditions;

FIG. 3 is a perspective view showing an alternate embodiment of the present invention, wherein the driver alert device includes a plurality of pins for assisting the driver of the dangerous driving conditions;

FIG. 4 is a high-level schematic block diagram showing the interrelationship between the major electronic components of the present invention; and

FIG. is a schematic block diagram showing the interrelationship between the electronic components of the neck position determining mechanism.

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes or proportions shown in the figures.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

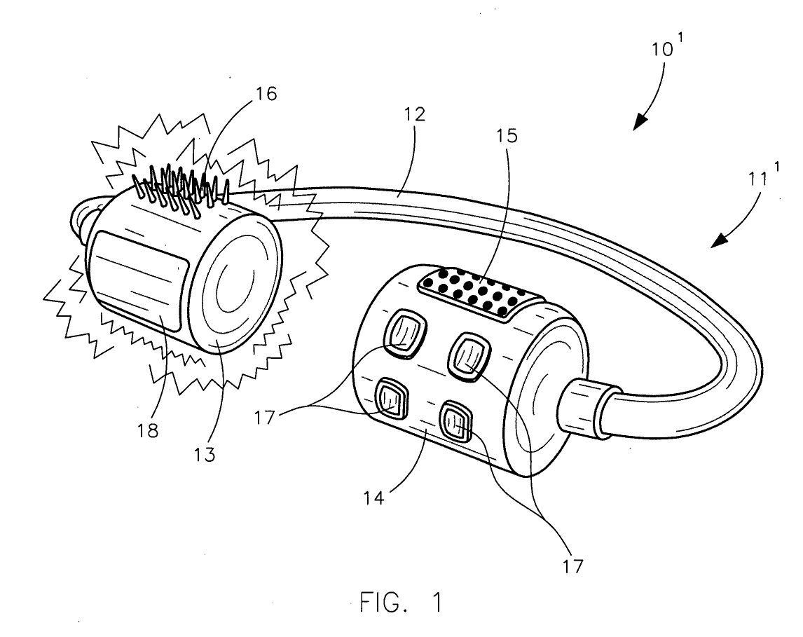

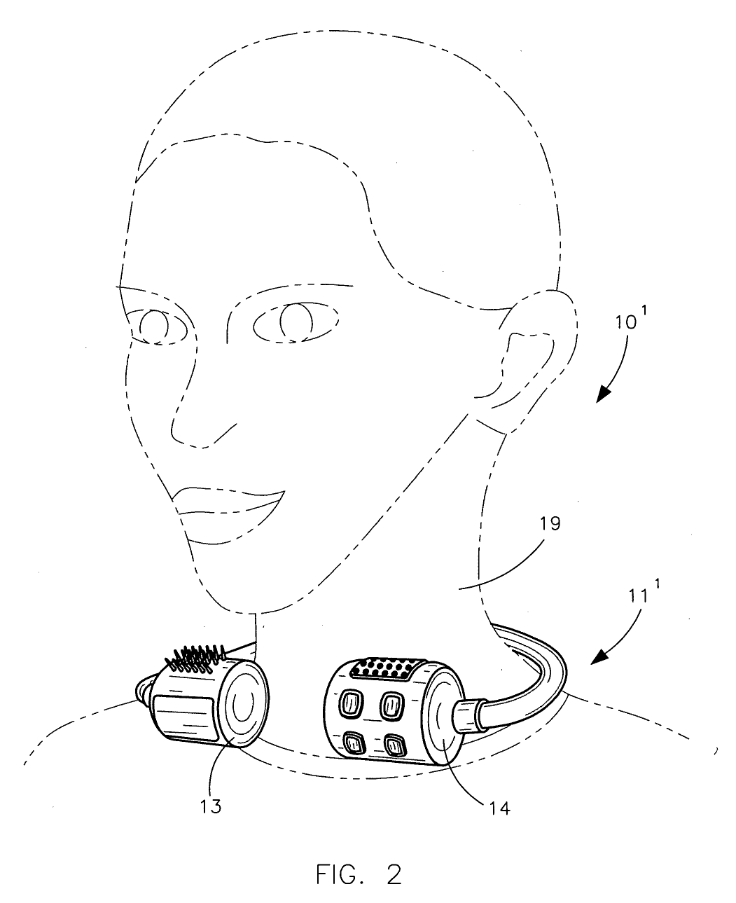

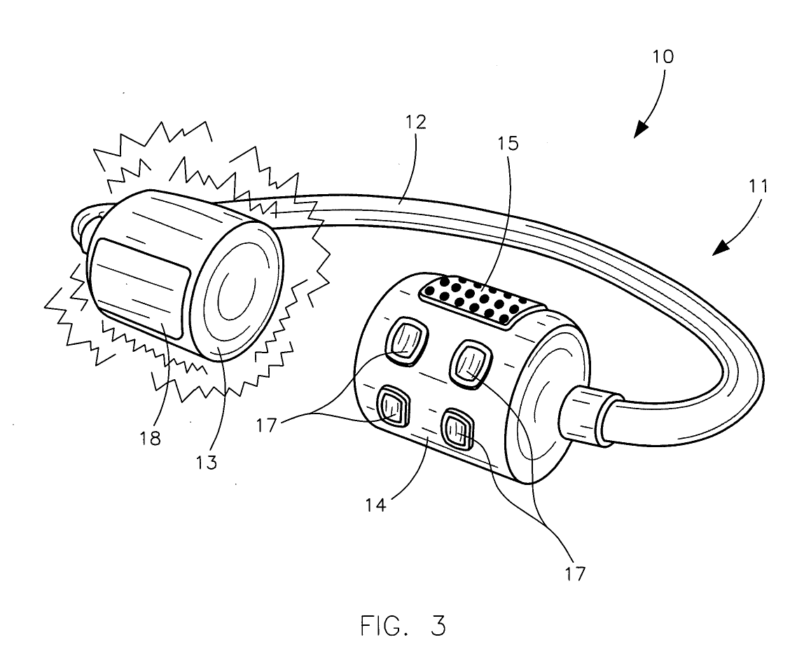

The driver alerting device of this invention is referred to generally in FIGS. 1-5 by reference numeral 10 and is intended to provide an electronic device that quickly alerts a driver of a dangerous driving condition associated with sleeping or nodding off at the wheel. It should be understood that the driver alerting device 10 may be used to alert various drivers of many different types of vehicles, water vessels, airplanes, etc. and should not be construed as limited to any particular application described hereinbelow.

The automatic driver alerting device 10 would offer a simple and convenient means of ensuring that weary drivers remain alert while behind the wheel. The present invention effectively helps motorists maintain awareness, whether they are driving during the day or at night.

As a result, device 10 effectively alleviates the risk of accidents on the roads, saving the lives of drivers wearing the product as well as their fellow motorists. While it should be noted that one who is extremely exhausted should not attempt to drive, the automatic alert device would prove invaluable in case sleepiness suddenly occurs while on the road. As such, students who spend too many waking hours studying, individuals who work night shifts and especially long distance truck drivers would certainly appreciate the benefits offered by this product.

The present invention describes an automatic driver alerting device 10 for notifying a driver when a dangerous event has occurred that is associated with sleeping at the wheel. The automatic driver alerting device 10 preferably includes a body 11 adapted to be removably positioned about a neck 19 of the driver. The compact and non-cumbersome body 11 is comfortably worn around the neck 19 and may be fabricated from a durable yet comfortable nylon material, and secured with strips of hook and loop fasteners commonly known as Velcro®, for example.

In one embodiment, the body 11 may include first and second chambers 13, 14 adapted to be positioned subjacent to a face of the driver. The body 11 may further include an intermediary coupling 12 having opposed ends directly anchored to the first and second chambers 13, 14 respectively. The intermediary coupling 12 is preferably adapted to conform to a shape of the driver neck 19 and thereby maintains the first and second chambers 13, 14 disposed anterior to the driver neck 19.

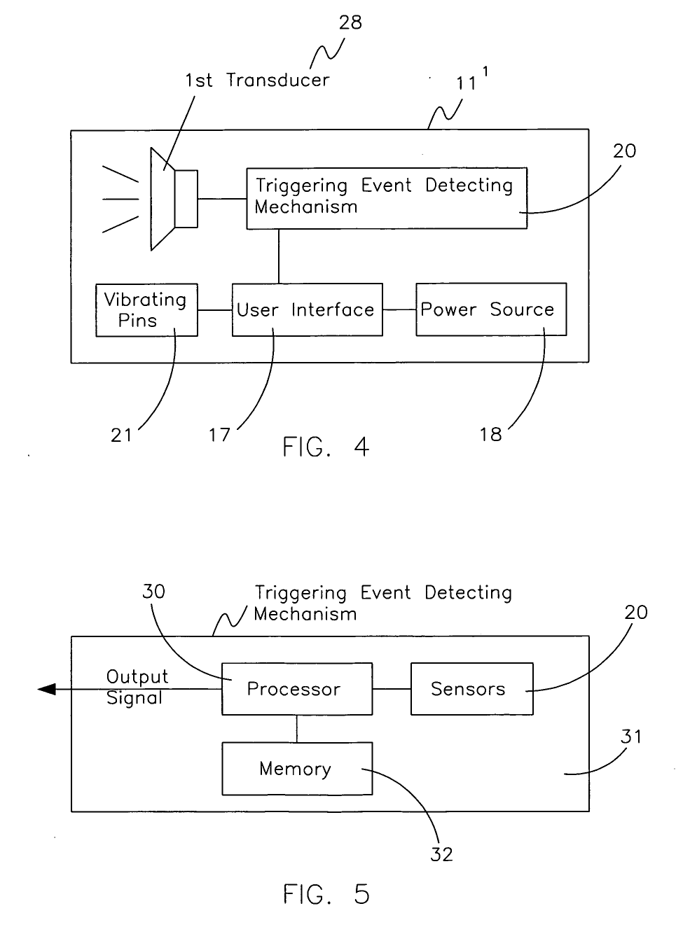

Referring to FIGS. 4-5, the present invention further includes a mechanism 20 for detecting an occurrence of a triggering event, such as when a driver doses off or falls asleep at the wheel while driving. Such a triggering event detecting mechanism 20 preferably generates and transmits start and stop output signals corresponding to a beginning and an end of the triggering event. A user interface 17 is also provided for generating and transmitting a control signal in response to receiving a user input.

The user interface 17 may include a variety of stand-alone or shared devices that are capable of generating and transmitting a control signal upon receiving a user input. For example, exemplary user interface 17 devices may include buttons directly positioned one of the chambers 13, 14, a remote controller employing RF, infra-red, acoustic or cellular technology, as well known in the industry. In alternate embodiments, the user interface 17 may include a handheld computer, a PDA, a cell phone, that may be comprised of commercially available hardware and software operating systems, for example.

The aforementioned user interfaces are intended to represent a broad category of exemplary user interfaces capable of functioning in accordance with the present invention. Of course, the user interface may include other components, peripherals and software applications provided they are compatible and capable of cooperating with remaining devices of the present invention. In addition, the user interface may include information, documents, data and files needed to provide functionality and enable performance of methodologies in accordance with an exemplary embodiment of the invention.

An internal power source 18 is electrically mated to the user interface 17 and a first transducer 28 is electrically coupled directly to the triggering event detecting mechanism 20. The power source 18 may include one or more rechargeable or non-rechargeable disposable batteries, photovoltaic cells, and/or an AC adapter or other power supply means. For example, power to the device could be provided by an internal battery source such as conventional alkaline batteries.

Advantageously, a first transducer 28 generates and emits a first alarm signal upon receiving the start output signal such that the first transducer 28 continuously emits the first alarm signal until receiving the stop output signal from mechanism 20. For example, the transducer may include an audio speaker, a light-emitting source, or a mechanical or electro-mechanical device that is capable of generating vibrations.

In one embodiment, the triggering event detecting mechanism 20 preferably includes a plurality of sensors 31 for detecting whether an external force is pressing downwardly against a top region of the body 11 (such as first and second chambers 13, 14, for example). Each of the sensors 31 generates and transmits a corresponding instruction signal upon detecting the external force. Each of the instruction signals preferably includes a first numerical value embedded therein. Such a first numerical value corresponds to an intensity of the real-time external force exerted on the body 11 so that the device 10 is able to distinguish between qualifying and non-qualifying external forces.

One or more sensor(s) 31, such as a motion and/or light sensor(s) may be provided to cause the present invention for detecting the triggering event, for example. Active and/or passive sensors 31 may be used to react to detectable subject matter such-as light, noise, radiation (e.g., heat), or changes in emitted energy, fields or beams. However, the invention is not limited to a particular type of sensor. Those skilled in the art will appreciate other sensors may be used without departing from the scope of the invention.

Examples of such other sensors include pressure sensitive mats; optical sensors configured to sense light; microwave sensors that use a Gunn diode operating within pre-set limits to transmit/flood a designated area/zone with an electronic field whereby movement in the zone disturbs the field and sets off an alarm; an ultrasonic sensor configured to react to a determined range of ultrasonic sound energy in a protected area; or any other sensor capable of providing external force and/or motion detection capability in accordance with principles of the invention.

Qualifying external forces are represented by a driver's chin or jaw continuously engaging the body 11 with a sufficient intensity associated with a face dropping directly on the body 11(such as first and second chambers 13, 14, for example). Non-qualifying external forces are represented by a quick or sudden jerk or recoil of the jaw or chin, which does not have a sufficient intensity or duration to identify a sleeping driver. As such, should the chin or jaw line drop, such as when the driver nods off, the face would press down on chambers 13, 14, which would then cause the sensors 31 to emit the instruction signals and ultimately cause transducers 21, 28 to sound an insistent buzzing or vibrating signal to rouse the driver, for example. As a result, the driver would then return his/her head to a safe driving position.

The triggering event detecting mechanism 20 may further include a processor 30 electrically coupled to the sensors 31, which is responsive to the instruction signals. The processor 30 may include a microprocessor or other devices capable of being programmed or configured to perform computations and instruction processing in accordance with the invention. Such other devices may include microcontrollers, digital signal processors (DSP), Complex Programmable Logic Device (CPLD), Field Programmable Gate Arrays (FPGA), application-specific integrated circuits (ASIC), discrete gate logic, and/or other integrated circuits, hardware or firmware in lieu of or in addition to a microprocessor.

Functions and process steps described herein may be performed using programmed computer devices and related hardware, peripherals, and equipment. When programmed, the computing devices are configured to perform functions and carry out steps in accordance with principles of the invention. Such programming may comprise operating systems, software applications, software modules, scripts, files, data, digital signal processors (DSP), application-specific integrated circuit (ASIC), discrete gate logic, or other hardware, firmware, or any conventional programmable software, collectively referred to herein as a module.

A memory 32 may be electrically coupled to the processor 30 and preferably includes programmable software instructions that cause the processor 30 to generate and transmit the start and stop signals to the transducers 21, 28, in one embodiment. The memory 32 includes programmable software instructions that are executed by the processor 30. In particular, the programmable software instructions include a plurality of chronological operating steps that define a control logic algorithm for performing the intended functions of the present invention. Such software instructions may be written in a variety of computer program languages such as C++, Fortran and Pascal, for example. One skilled in the art understands that such software instructions may contain various Boolean logic processes that perform the intended function of the present invention. Therefore, the specific source or object code of the software program is not intended to be a limiting factor in executing the present invention's intended function.

The memory 32, which enables storage of data and programs, may include RAM, ROM, flash memory and any other form of readable and writable storage medium known in the art or hereafter developed. The memory 32 may be a separate component or an integral part of another component such as processor 30.

The software instructions preferably include and execute a control logic algorithm that determines whether the instruction signals are qualified instruction signals based upon a user defined minimum operating parameter. The user defined minimum operating parameter preferably includes a minimum numerical value embedded in the control signal. Such a minimum numerical value corresponds to a minimum external force necessary to qualify the detected event as the triggering event, as explained hereinabove.

Notably, the control logic algorithm includes the chronological steps of: requesting the control signal from the user; receiving and extracting the minimum numerical value from the control signal; and receiving and extracting the real-time numerical values from the instruction signals respectively. If at least one of the real-time numerical values is greater than the minimum numeral value, then the processor 30 generates and transmits a first one of the start signals to the first transducer 28, for example. If the real-time numerical values are less than the minimum numeral value, then the processor 30 generates and transmits a first one of the stop signals to the first transducer 28, for example.

In one embodiment 10′, the present may further include a second transducer 21 electrically coupled to the triggering event detecting mechanism 20. The second transducer 21 generates and transmits a second alarm signal upon receiving a second one of the start and stop output signals respectively. Accordingly, the control logic algorithm may further include the chronological steps of: if at least one of the real-time numerical values is greater than the minimum numeral value, then generating and transmitting the second one of the start signals to the second transducer 21; and if the real-time numerical values are less than the minimum numeral value, then generating and transmitting a second one of the stop signals to the second transducer 21.

The present invention may further include a method for notifying a driver when a dangerous event has occurred that is associated with sleeping at the wheel. Such a method preferably includes the chronological steps of: providing a body 11 including first and second chambers 13, 14 and an intermediary coupling 12. The intermediary coupling 12 preferably has opposed ends directly anchored to the first and second chambers 13, 14 respectively. The method further includes the chronological step of removably positioning the body 11 about a neck 19 of the driver by conforming the intermediary coupling 12 to a shape of the driver neck 19; and positioning the first and second chambers 13, 14 subjacent to a face of the driver.

The method may further include the chronological steps of: maintaining the first and second chambers 13, 14 anterior to the driver neck 19; providing a user interface 17 for generating and transmitting a control signal in response to receiving a user input; providing an internal power source 18 electrically mated to the user interface 17; and providing a mechanism 20 for detecting an occurrence of a triggering event.

The method may further include the chronological steps of: providing and electrically coupling a first transducer 28 directly to the triggering event detecting mechanism 20; the triggering event detecting mechanism 20 generating and transmitting start and stop output signals corresponding to a beginning and an end of the triggering event respectively; the first transducer 28 generating and emitting a first alarm signal upon receiving the start output signal; and the first transducer 28 continuously emitting the first alarm signal until receiving the stop output signal.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. An automatic driver alerting device for notifying a driver when a dangerous event has occurred that is associated with sleeping at the wheel, said automatic driver alerting device comprising: a body adapted to be removably positioned about a neck of the driver, said body comprising
means for detecting an occurrence of a triggering event, said triggering event detecting means generating and transmitting start and stop output signals corresponding to a beginning and an end of said triggering event;
a user interface for generating and transmitting a control signal in response to receiving a user input;
an internal power source electrically mated to said user interface; and
a first transducer electrically coupled directly to said triggering event detecting means, said first transducer generating and emitting a first alarm signal upon receiving said start output signal;
wherein said first transducer continuously emits said first alarm signal until receiving said stop output signal.

2. The automatic driver alerting device of claim 1, wherein said triggering event detecting means comprises:
a plurality of sensors for detecting whether an external force is pressing downwardly against a top region of said body, each of said sensors generating and transmitting a corresponding instruction signal upon detecting said external force, each of said instruction signals comprising a first numerical value embedded therein, said first numerical value corresponding to an intensity of said real-time external force exerted on said body.

3. The automatic driver alerting device of claim 2, wherein said triggering event detecting means further comprises:
a processor electrically coupled to said sensors and being responsive to said instruction signals; and
a memory electrically coupled to said processor and including programmable software instructions that cause said processor to generate and transmit said start and stop signals to said first transducer, said software instructions comprising and executing a control logic algorithm that determines whether said instruction signals are qualified instruction signals based upon a user defined minimum operating parameter;
wherein said user defined minimum operating parameter comprises a minimum numerical value embedded in said control signal, said minimum numerical value corresponding to a minimum external force necessary to qualify as said triggering event.

4. The automatic driver alerting device of claim 3, wherein said control logic algorithm comprises the chronological steps of:
a. requesting said control signal from the user;
b. receiving and extracting said minimum numerical value from said control signal;
c. receiving and extracting said real-time numerical values from said instruction signals respectively;
d. if at least one of said real-time numerical values is greater than said minimum numeral value, then generating and transmitting a first one of said start signals to said first transducer; and
e. if said real-time numerical values are less than said minimum numeral value, then generating and transmitting a first one of said stop signals to said first transducer.

5. The automatic driver alerting device of claim 4, further comprising:
a second transducer electrically coupled to said triggering event detecting means, said second transducer generating and transmitting a second alarm signal upon receiving a second one of said start and stop output signals respectively.

6. The automatic driver alerting device of claim 5, wherein said control logic algorithm further comprises the chronological steps of:
f. if at least one of said real-time numerical values is greater than said minimum numeral value, then generating and transmitting said second one of said start signals to said second transducer; and
g. if said real-time numerical values are less than said minimum numeral value, then generating and transmitting a second one of said stop signals to said second transducer.

7. An automatic driver alerting device for notifying a driver when a dangerous event has occurred that is associated with sleeping at the wheel, said automatic driver alerting device comprising: a body adapted to be removably positioned about a neck of the driver, said body comprising
first and second chambers adapted to be positioned subjacent to a face of the driver;
an intermediary coupling having opposed ends directly anchored to said first and second chambers respectively, said intermediary coupling being adapted to conform to a shape of the driver neck and thereby maintain said first and second chambers anterior to the driver neck;
means for detecting an occurrence of a triggering event, said triggering event detecting means generating and transmitting start and stop output signals corresponding to a beginning and an end of said triggering event;
a user interface for generating and transmitting a control signal in response to receiving a user input;
an internal power source electrically mated to said user interface; and
a first transducer electrically coupled directly to said triggering event detecting means, said first transducer generating and emitting a first alarm signal upon receiving said start output signal;
wherein said first transducer continuously emits said first alarm signal until receiving said stop output signal.

8. The automatic driver alerting device of claim 7, wherein said triggering event detecting means comprises:
a plurality of sensors for detecting whether an external force is pressing downwardly against a top region of said body, each of said sensors generating and transmitting a corresponding instruction signal upon detecting said external force, each of said instruction signals comprising a first numerical value embedded therein, said first numerical value corresponding to an intensity of said real-time external force exerted on said body.

9. The automatic driver alerting device of claim 8, wherein said triggering event detecting means further comprises:
a processor electrically coupled to said sensors and being responsive to said instruction signals; and
a memory electrically coupled to said processor and including programmable software instructions that cause said processor to generate and transmit said start and stop signals to said first transducer, said software instructions comprising and executing a control logic algorithm that determines whether said instruction signals are qualified instruction signals based upon a user defined minimum operating parameter;
wherein said user defined minimum operating parameter comprises a minimum numerical value embedded in said control signal, said minimum numerical value corresponding to a minimum external force necessary to qualify as said triggering event.

10. The automatic driver alerting device of claim 9, wherein said control logic algorithm comprises the chronological steps of:
a. requesting said control signal from the user;
b. receiving and extracting said minimum numerical value from said control signal;
c. receiving and extracting said real-time numerical values from said instruction signals respectively;
d. if at least one of said real-time numerical values is greater than said minimum numeral value, then generating and transmitting a first one of said start signals to said first transducer; and
e. if said real-time numerical values are less than said minimum numeral value, then generating and transmitting a first one of said stop signals to said first transducer.

11. The automatic driver alerting device of claim 10, further comprising:
a second transducer electrically coupled to said triggering event detecting means, said second transducer generating and transmitting a second alarm signal upon receiving a second one of said start and stop output signals respectively.

12. The automatic driver alerting device of claim 11, wherein said control logic algorithm further comprises the chronological steps of:
f. if at least one of said real-time numerical values is greater than said minimum numeral value, then generating and transmitting said second one of said start signals to said second transducer; and
g. if said real-time numerical values are less than said minimum numeral value, then generating and transmitting a second one of said stop signals to said second transducer.

13. A method for notifying a driver when a dangerous event has occurred that is associated with sleeping at the wheel, said method comprising the chronological steps of:
providing a body including first and second chambers and an intermediary coupling, said intermediary coupling having opposed ends directly anchored to said first and second chambers respectively;
removably positioning said body about a neck of the driver by conforming said intermediary coupling to a shape of the driver neck;
positioning said first and second chambers subjacent to a face of the driver;
maintaining said first and second chambers anterior to the driver neck;
providing a user interface for generating and transmitting a control signal in response to receiving a user input;
providing an internal power source electrically mated to said user interface;
providing a mechanism for detecting an occurrence of a triggering event,
providing and electrically coupling a first transducer directly to said triggering event detecting mechanism;
said triggering event detecting mechanism generating and transmitting start and stop output signals corresponding to a beginning and an end of said triggering event respectively;
said first transducer generating and emitting a first alarm signal upon receiving said start output signal; and
said first transducer continuously emitting said first alarm signal until receiving said stop output signal.
